(19) United States
(12) Patent Application Publication
(10) Pub. No.: US 2003/0163938 A1
(43) Pub. Date: Sep. 4, 2003

(54) Jewelry design selection device and method thereof

(76) Inventor: Charles L. Norton, Marietta, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/087,435

(22) Filed: Mar. 1, 2002

(51) Int. Cl. G09F 11/02

(52) U.S. Cl. 40/493

(57) ABSTRACT

A jewelry design selection device and a method thereof, wherein a user may select a setting from a plurality of settings and view a plurality of stone configurations therein, or may select a stone and view a plurality of setting configurations therefor, thereby assisting the user with design selection and, in the preferred embodiment, creating a record and/or order of the same.

### TECHNICAL FIELD

The present invention relates generally to jewelry and, more specifically, to a jewelry design selection device and a method thereof, wherein a user may select a setting from a plurality of settings and view a plurality of stone configurations therein, or may select a stone and view a plurality of setting configurations therefore, thereby assisting the user with design selection and, in the preferred embodiment, creating a record and/or order of the same.

### BACKGROUND OF THE INVENTION

Jewelry seems to have an essentially universal appeal. Throughout history, physical adornment with precious metals and gems has remained prevalent and seems to endure despite continually changing fashion and accessory trends worldwide. It is perhaps the availability of virtually limitless setting designs, precious and semi-precious gemstones, natural and simulated pearls, precious metals and the combination thereof, that enables the continued allure of jewelry.

The endless variety of combinations, however, can complicate the selection process. For instance, if an individual desires to purchase a piece of jewelry, it is often first necessary to decide upon a broad category, such as rings, bracelets, necklaces, earrings or other type of body jewelry. The plethora of options available within each category can make such a decision difficult. Moreover, even when an individual has a predetermined category in mind, the selection process can still be daunting.

Many consumers visit jewelry stores and select from the available stock on display. While this method of selection may simplify the process, it is the disadvantageously direct result of a limitation in design options. In an attempt to offer a larger variety of combinations, some jewelers display settings without stones and allow the buyer to select the particular stone type, size, shape and/or color of preference from a non-mounted stock. This does provide the buyer with a greater selection than pre-mounted stock, but is still limited by the jeweler's ability to maintain a large inventory.

Another method of selection utilized by some jewelers enables a buyer to create a generally custom combination by providing catalog photographs or drawings of available settings and potential stones. Unfortunately, it is difficult for many individuals to look from a gemstone catalog or photograph to a printed picture of a setting and imagine the stone set therein. Moreover, often after viewing such a large number of selections, it may be difficult for the buyer to recall his or her final choice.

Therefore, it is readily apparent that there is a need for a jewelry design selection device and a method thereof, wherein a user may select a setting from a plurality of settings and view a plurality of stone configurations therein, or may select a stone and view a plurality of setting configurations therefor, thereby assisting the user with design selection and, in the preferred embodiment, creating a record and/or order of the same, thus preventing the above-discussed disadvantages.

### BRIEF SUMMARY OF THE INVENTION

Briefly described, in a preferred embodiment, the present invention overcomes the above-mentioned disadvantages and meets the recognized need for such a device by providing a jewelry selection device and method thereof enabling a user to effectively visualize virtually limitless combinations of setting designs, precious and semi-precious gemstones, natural and simulated pearls and/or precious metals.

According to its major aspects and broadly stated, the present invention is a jewelry design selection device and a method thereof, wherein a user may select a setting from a plurality of settings and view a plurality of stone configurations therein, or may select a stone and view a plurality of setting configurations therefor, thereby assisting the user with design selection and, in the preferred embodiment, creating a record and/or order of the same.

More specifically, the present invention is a jewelry selection device and method thereof, wherein a user can select and view a setting and stone combination, can quickly and easily change either the setting or the stone or both to view another combination, and can create a record of the preferred selection. The preferred device is generally a flat sleeve having at least one viewing window defined therein, wherein interchangeable jewelry selections are visualized therethrough.

In the preferred embodiment, a first rotationally mounted, circular shaped display card is positioned within the sleeve, wherein user access thereto enables rotation thereof. The first display card preferably has a plurality of jewelry settings illustrated thereon, wherein the plurality of settings is generally circularly arranged to enable rotational selection of a setting for visualization through the view window on the sleeve. Preferably, a second rotationally mounted circular display card is opposingly positioned within the sleeve, wherein the second display card is generally transparent and wherein user access thereto enables rotation thereof. The second display card preferably has a plurality of gemstones illustrated thereon, wherein the plurality of gemstones is generally circularly arranged to enable rotational selection of a gemstone for visualization through the view window on the sleeve, and wherein the second display card is preferably positioned on top of the first display card thus enabling coincidental display of the selected gemstone and the selected setting, thereby visualizing the combination thereof in the view window on the sleeve.

In the preferred form, the sleeve has additional view windows, wherein additional information included on the first display card such as, for exemplary purposes only, setting style number, price and/or specifications, is displayed therethrough, and wherein additional information included on the second display card such as, for exemplary purposes only, stone size, price and/or specifications, is displayed therethrough.

Preferably, the sleeve is formed from generally sturdy card stock paper, thereby enabling inexpensive manufacture thereof and printing thereon. In the preferred embodiment, the sleeve is imprinted with customer data inquiries such as, for exemplary purposes only, name, contact information, order date, estimated completion date, size data, pricing and jewelry article specifications. Preferably, the responses to the inquiries are logged and a permanent record is created of the selection and/or order.

A feature and advantage of the present invention is the ability of such a method and device to enable a user to effectively visualize virtually limitless combinations of setting designs, precious and semi-precious gemstones, natural and simulated pearls and/or precious metals.

Another feature and advantage of the present invention is the ability of such a method and device to reduce the necessary inventory for a jeweler.

Another feature and advantage of the present invention is the ability of such a method and device to assist in jewelry design selection.

Another feature and advantage of the present invention is the ability of such a method and device to enable a user to select a setting from a plurality of settings and view a plurality of stone configurations therein.

Another feature and advantage of the present invention is the ability of such a method and device to enable a user to select a stone and view a plurality of setting configurations therefor.

Another feature and advantage of the present invention is the ability of such a method and device to create a record of design selection.

Another feature and advantage of the present invention is the ability of such a method and device to generate an order form for a design selection.

Another feature and advantage of the present invention is the ability of such a method and device to provide an inexpensive means for exhibiting countless arrangements of jewels and gems.

Another feature and advantage of the present invention is the ability of such a method and device to enable a user to quickly and easily exchange a setting and/or stone to view another combination.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a top view of a jewelry design selection apparatus according to a preferred embodiment of the present invention, showing a ring setting and stone selection in a view window.

FIG. 2 is a top view of the jewelry design selection apparatus of FIG. 1, showing a first display card with ring settings displayed thereon.

FIG. 3 is a top view of the jewelry design selection apparatus of FIG. 1, showing a second display card with gemstones displayed thereon.

FIG. 4 is a top view of a jewelry design selection apparatus according to an alternate embodiment of the present invention, showing a sleeve cover with a selection of rings displayed thereon.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

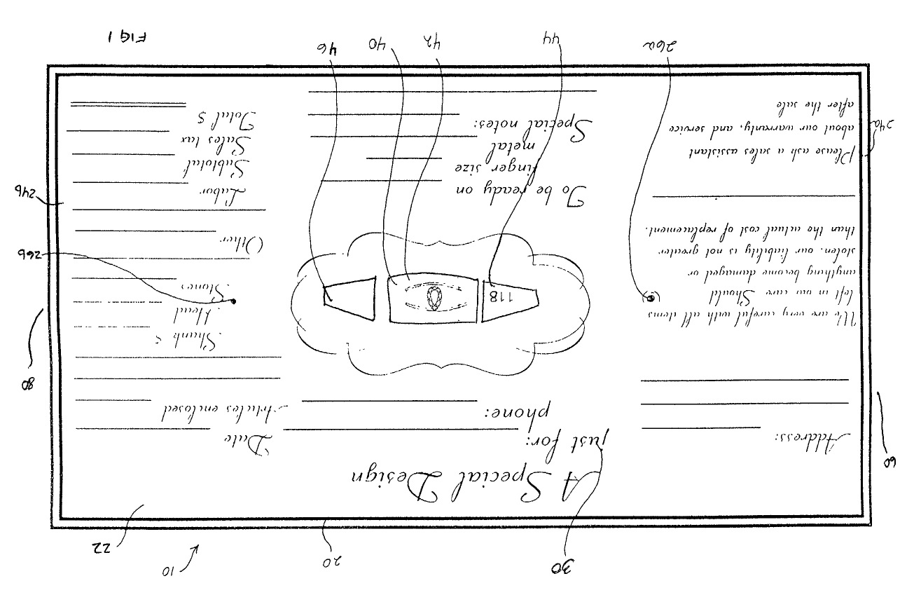

Referring now to FIG. 1, in its preferred form the present invention is jewelry selection device 10 having display format 20, visual display 40, first visual display selector 60 and second visual display selector 80. Preferably, display format 20 is generally flat sleeve 22, wherein sleeve 22 is preferably formed from card stock paper. While card stock paper is preferred for sleeve 22, other materials could be alternately utilized without departing from the intended scope of the present invention such as, for exemplary purposes only, any weight of paper, cardboard, poster board, plastic, metal, wood, or any other suitable material.

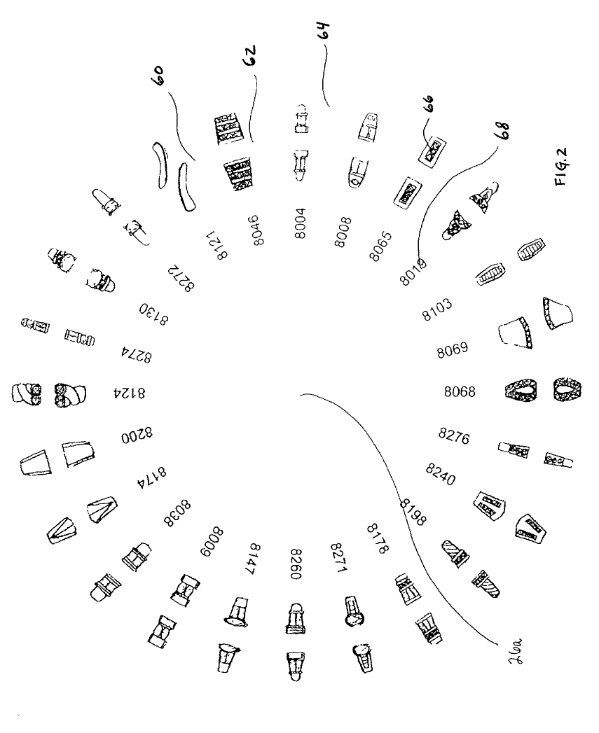

Preferably, sleeve 22 has visual display 40 defined therein, wherein visual display 40 is preferably viewing window 42. First visual display selector 60 is preferably generally flat, generally circular first display card 62, best seen in FIG. 2. In the preferred embodiment, first display card 62 is preferably rotationally mounted to sleeve 22, wherein rotational mount 26a for first display card 62 preferably does not extend through front surface 28 of sleeve 22. One skilled in the art would readily recognize, however, that rotational mount 26a could extend through front surface 28 of sleeve 22 or could be otherwise configured without departing from the intended scope of the present invention. In the preferred embodiment, rotational mount 26a is a rivet. However, other suitable rotational mounts such as, for exemplary purposes only, pins, brads or any other suitable mount may be utilized.

Preferably, peripheral edge 64 of first display card 62 extends from first end 24a of sleeve 22, whereby a user can access first display card 62 and activate rotational movement thereof. Alternatively, a small portion may be cut out of first end 24a of sleeve 22 to allow access to peripheral edge 64. In the preferred form, first display card 62 is printed with a plurality of jewelry setting designs 66. For assistance with ring design selection, first display card 62 is printed with a plurality of ring settings. For assistance with necklace design selection, first display card 62 is printed with a plurality of necklace settings; and so on for any and all other types and articles of jewelry. Preferably, the plurality of jewelry settings 66 is radially arranged, wherein user rotation of first display card 62 enables a selection and viewing of one of the plurality of jewelry settings 66 through viewing window 42.

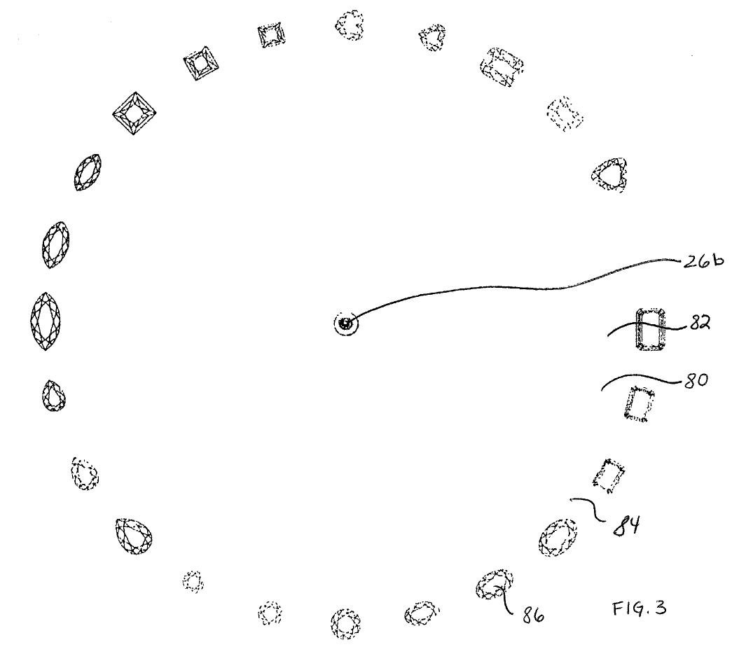

Second visual display selector 80 is preferably generally flat, generally circular second display card 82, best seen in FIG. 3. In the preferred embodiment, second display card 82 is preferably rotationally mounted to sleeve 22, wherein rotational mount 26b for second display card 82 preferably does not extend through front surface 28 of sleeve 22. One skilled in the art would readily recognize, however, that rotational mount 26b could extend through front surface 28 of sleeve 22 or could be otherwise configured without departing from the intended scope of the present invention. In the preferred embodiment, rotational mount 26b is a rivet. However, other suitable rotational mounts such as, for exemplary purposes only, pins, brads or any other suitable mount may be utilized.

Preferably, peripheral edge 84 of second display card 82 extends from second end 24b of sleeve 22, whereby a user can access second display card 82 and activate rotational movement thereof. Alternatively, a small portion may be cut out of second end 24b of sleeve 22 to allow access to peripheral edge 84. Preferably, second display card 82 is mounted to enable it to overlap with first display card 62. In the preferred form, second display card 82 is substantially transparent and is printed with a plurality of gemstones 86. Preferably, the plurality of gemstones 86 is radially arranged on second display card 82, wherein user rotation of second display card 82 enables a selection and viewing of one of the plurality of gemstones 86 through viewing window 42 with coincident viewing of one of the plurality of jewelry settings 66 of first display card 62 through viewing window 42 and through substantially transparent second display card 82.

In the preferred form, sleeve 22 has second window 44 and third window 46 defined therein. Preferably, a plurality of setting information 68 is printed on first display card 62 such as, for exemplary purposes only, setting style number, price and/or other specifications, wherein user selection and display of one of the plurality of settings 66 through viewing window 42 enables coincident viewing an appropriate selection from the plurality of setting information 68 through second window 44. Preferably, a plurality of gemstone information (not shown) is printed on second display card 82 such as, for exemplary purposes only, stone size, price and/or other specifications, wherein user selection and display of one of the plurality of gemstones 86 through viewing window 42 enables coincident viewing an appropriate selection from the plurality of gemstone information 88 through third window 46.

In the preferred embodiment, sleeve 22 is imprinted with a plurality of data inquiries 30 such as, for exemplary purposes only, name, contact information, order date, estimated completion date, size data, pricing and jewelry article specifications. Preferably, user responses to the plurality of data inquiries 30 are logged onto sleeve 22, wherein a record and/or order form is created as a result thereof.

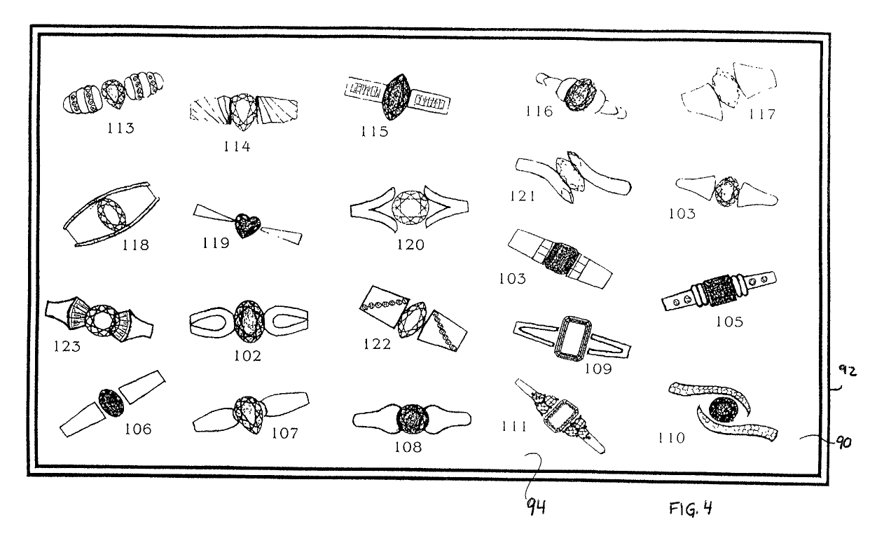

As best seen in FIG. 4, in an alternate embodiment, jewelry design selection device 10 has cover 90 provided thereon, wherein cover 90 is hingedly or foldably positioned proximate to sleeve 22. Cover 90 has outer surface 92 and inner surface 94, wherein inner surface 94 rests proximate to sleeve 22 when cover 90 is in a closed position. When cover 90 is in an open position, inner surface 94 is visible to a user, wherein a plurality of setting and gemstone combinations is referenced thereon. When cover 90 is in a closed position, outer surface 92 is visible to a user, wherein jeweler identification, logo imprinting or other advertising can be provided.

In an alternate embodiment, sleeve 22 could carry a removable overlay, wherein information recorded thereon could be removed from jewelry design selection device 10 and jewelry design selection device 10 could be re-utilized.

In an alternate embodiment, sleeve 22 could carry a pad, wherein each sheet could have information recorded thereon, could be removed from jewelry design selection device 10, and a new blank sheet could be available for a subsequent user.

In an alternate embodiment, sleeve 22 could have an outer sleeve, wherein information recorded thereon could be removed from jewelry design selection device 10 and jewelry design selection device 10 could be re-utilized.

In an alternate embodiment, sleeve 22 could have a plurality of overlays and carbon or transfer paper provided therebetween, wherein multiple copies of information recorded on sleeve 22 could be created.

In an alternate embodiment, sleeve 22 could have a non-permanent marking surface, wherein a copy of recorded information and jewelry design selection could be made, and information could be removed to enable subsequent utilization of jewelry design selection device 10.

In an alternate embodiment, jewelry design selection device 10 could carry additional visual display selectors, wherein a larger variety of features could be visualized, including but not limited to, available chain types for necklace settings, additional or accompanying gemstones for placement proximate to a main gemstone mount, and/or jackets.

In an alternate embodiment, first display card 62 could have a window defined therein and sleeve 22 could have any number of additional first display cards with additional selections printed thereon, wherein the additional first display cards could be rotationally and coaxially mounted with first display card 62, whereby alignment of the window on first display card 62 and/or any additional first display cards within viewing window 42 could enable visualization of the subsequent additional first display card.

In an alternate embodiment, first display card 62 and/or second display card 82 could be removable.

In an alternate embodiment, first display card 62 and second display card 82 could be generally rectangular shaped and slidably carried within sleeve 22, wherein longitudinal movement thereof could enable user selection from a variety of settings and gemstones, respectively. Moreover, additional rectangular shaped cards could be provided, thereby enabling removal and insertion of a plurality of cards in a plurality of combinations, thus increasing the available jewelry design selections.

In an alternate embodiment, at least one additional window could be defined in sleeve 22 and additional material could be printed on first display card 62, wherein user selection and display of a setting design in viewing window 42 could coincide with a list of recommended gemstone qualities, shapes and/or sizes best suited for the selected setting design.

In an alternate embodiment, at least one additional window could be defined in sleeve 22 and additional material could be printed on second display card 82, wherein user selection and display of a gemstone in viewing window 42 could coincide with a list of recommended setting designs or styles best suited for the selected gemstone, or could coincide with a list of prices for a range of gemstone weights.

In an alternate embodiment, display format 20 could be graphic or digital image on a computer display, wherein the display could be any type of computer display such as, for exemplary purposes only a monitor, laptop, projection screen, personal data device screen or any other suitable graphic or digital image display device. First visual display selector 60 could be a first input button, wherein a user could choose to enter data such as, for exemplary purposes only, a style number, type of precious metal or other setting specification to view a particular setting design, or wherein a user could scroll through available setting designs. Second visual display selector 80 could be a second input button, wherein a user could choose to enter data such as, for exemplary purposes only, a gemstone type, weight or other gemstone specification to view a particular gemstone, or wherein a user could scroll through available gemstones. The combination of selections from first input button and second input button could be displayed on visual display 40, wherein additional buttons could be provided to enable a three-dimensional image of the created design combination to be viewed from different angles and perspectives. The graphic or digital image thereof could be printed, could be downloaded to a data storage device, or could be transferred to an order file for further processing.

In an alternate embodiment, first display card 62 and second display card 82 could be generally octagonal, hexagonal or could be any other suitable shape.

In an alternate embodiment, peripheral edge 64 of first display card 62 and peripheral edge 84 of second display card 82 could be user accessible and rotatable from any position relative to sleeve 22.

In an alternate embodiment, first display card 62 could be substantially transparent and second display card 82 could be substantially opaque, wherein first display card 62 could overlap with second display card 82.

In an alternate embodiment, first display card 62 and second display card 82 could be substantially transparent.

In an alternate embodiment, first display card 62 and second display card 82 could each display any component part of an article of jewelry or a combination thereof.

In an alternate embodiment, jewelry design selection device 10 could be utilized for costume jewelry and/or for a combination of synthetic and precious and/or semi-precious components.

In the preferred use, jewelry design selection device 10 is provided to a consumer, wherein cover 90 is placed in an open position to enable visualization of inner surface 94 and any printed display thereon, and to enable visualization of sleeve 22. Preferably, a user rotates first display card 62 by accessing peripheral edge 64 thereof, viewing setting designs of the plurality of jewelry setting designs 66 through viewing window 42 and selecting a jewelry setting design for continued display. Preferably, a user rotates second display card 82 by accessing peripheral edge 84 thereof, viewing gemstone designs of the plurality of gemstones 86 through viewing window 42 with coincident viewing of the selection from the plurality of jewelry settings 66 of first display card 62 through viewing window 42 and through substantially transparent second display card 82. In the preferred form, the combined selection and display also enables viewing of setting information 68 through second window 44 and gemstone information through third window 46. The plurality of data inquiries 30 is completed by the user and/or jeweler, thereby creating a permanent record and/or order form.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated or described herein, but is limited only by the following claims.

What is claimed is:

1. A jewelry selection device, comprising:
a display platform;
a display, said display enabling viewing of at least one of a plurality of jewelry selections;
a first means for making a first at least one selection from a plurality of jewelry selection components, said at least one selection from said plurality of jewelry selection components exhibited by said display; and
a second means for making a second at least one selection from said plurality of jewelry selection components, said at least one selection from said plurality of jewelry selection components exhibited by said display,
wherein the coincident display of said first at least one selection from said plurality of jewelry selection components and said second at least one selection from said plurality of jewelry selection components enables viewing of said at least one of said plurality of jewelry selections.

2. The jewelry selection device of claim 1, wherein said display platform is a generally flat sleeve having a first surface and a second surface, and wherein said display is at least one viewing aperture defined by said first surface.

3. The jewelry selection device of claim 2, wherein said first means for making a first at least one selection from a plurality of jewelry selection components is a first at least one generally circular card, wherein said second means for making a second at least one selection from a plurality of jewelry selection components is a second at least one generally circular card, wherein said first at least one generally circular card and said second at least one generally circular card are rotationally carried by said sleeve, and wherein at least one of said generally circular cards is substantially transparent.

4. The jewelry selection device of claim 1, wherein said display platform has a plurality of data inquiries.

5. The jewelry selection device of claim 2, wherein said first surface of said sleeve carries a plurality of data inquiries.

6. The jewelry selection device of claim 2, further comprising a cover, said cover carried by said sleeve.

7. The jewelry selection device of claim 5, wherein said first surface carries at least one removable coversheet.

8. The jewelry selection device of claim 7, wherein said first surface carries more than one removable coversheet and at least one data transfer sheet is positioned between a first coversheet and a second coversheet enabling at least duplicate completion of said plurality of data inquiries.

9. The jewelry selection device of claim 2, further comprising an outer sleeve having a first surface, wherein said outer sleeve substantially carries said sleeve and wherein said first surface of said outer sleeve carries a plurality of data inquiries.

10. The jewelry selection device of claim 5, wherein said first surface of said sleeve is a non-permanent marking surface.

11. The jewelry selection device of claim 1, further comprising at least one additional means for making at least one additional selection from a plurality of jewelry selection components, said at least one selection from said plurality of jewelry selection components exhibited by said display,
wherein the coincident display of said at least one additional selection from said plurality of jewelry selection components, said first at least one selection from said plurality of jewelry selection components and said second at least one selection from said plurality of jewelry selection components enables viewing of said at least one of said plurality of jewelry selections.

12. The jewelry selection device of claim 2, wherein said means for making a first at least one selection from a plurality of jewelry selection components is a first plurality of generally circular cards, wherein said second means for making a second at least one selection from a plurality of jewelry selection components is a second plurality of generally circular cards, wherein said first plurality of generally circular cards are coaxially and rotationally carried by said sleeve, wherein said second plurality of generally circular cards are coaxially and rotationally carried by said sleeve, wherein at least one of said plurality of generally circular cards is substantially transparent, and wherein each card of said first plurality of generally circular cards and each card of said second plurality of generally circular cards has at least one viewing aperture defined therethrough.

13. The jewelry selection device of claim 3, wherein said first at least one generally circular card and said second at least one generally circular card are removable.

14. The jewelry selection device of claim 1, wherein said display platform is a computer, said display is a graphical image, said first means for making a first at least one selection from a plurality of jewelry selection components is a first interactive graphical interface, and said second means for making a second at least one selection from said plurality of jewelry selection components is a second interactive graphical interface.

15. The jewelry selection device of claim 14, wherein said graphical image is storable.

16. A visualization device for viewing a plurality of jewelry designs, comprising:
a display casing having a first surface and a second surface;
at least one viewing window, said viewing window defined in said first surface of said display casing for viewing said plurality of jewelry designs;
a first at least one rotatable wheel, said first rotatable wheel imprinted with a first selection of a plurality of jewelry design components, at least one selection from said first selection of said plurality of jewelry design components displayed in said viewing window;
a second at least one rotatable wheel, said second rotatable wheel imprinted with a second selection of a plurality of jewelry design components, at least one selection from said second selection of said plurality of jewelry design components displayed in said viewing window;
wherein the coincident display of said first at least one selection from said plurality of jewelry design components and said second at least one selection from said plurality of jewelry design components enables visualization of at least one of said plurality of jewelry designs.

17. The visualization device for viewing a plurality of jewelry designs of claim 16, further comprising a cover foldably carried by said display casing, wherein said first surface of said display casing is imprinted with a plurality of informational inquiries and wherein said cover is imprinted.

18. A method of selecting a jewelry design, comprising the steps of:
a) obtaining a jewelry selection device having a display platform, a display, a first means for making a first at least one selection from a plurality of jewelry selection components, said at least one selection from said plurality of jewelry selection components exhibited by said display, and a second means for making a second at least one selection from said plurality of jewelry selection components, said at least one selection from said plurality of jewelry selection components exhibited by said display;
b) utilizing said first means for making a first at least one selection from said plurality of jewelry selection components;
c) utilizing said second means for making a second at least one selection from said plurality of jewelry selection components; and
d) viewing the coincident display of said first at least one selection from said plurality of jewelry selection components and said second at least one selection from said plurality of jewelry selection components.

19. The method of jewelry selection of claim 18, wherein said display platform is a sleeve, wherein said first means for making a first at least one selection from a plurality of jewelry selection components is a first at least one generally circular card, and wherein said second means for making a second at least one selection from a plurality of jewelry selection components is a second at least one generally circular card, wherein said first at least one generally circular card and said second at least one generally circular card are rotationally carried by said sleeve, and wherein at least one of said generally circular cards is substantially transparent.

20. The method of jewelry selection of claim 18, wherein said jewelry selection device has a plurality of data inquiries, and further comprising the steps of:
e) answering said data inquiries; and
f) utilizing said responses to said data inquiries to generate an order record.
